(19) United States
(12) Patent Application Publication
(10) Pub. No.: US 2010/0220975 A1
(43) Pub. Date: Sep. 2, 2010

(54) INFORMATION PRESENTATION APPARATUS AND INFORMATION PRESENTATION METHOD

(75) Inventors: Tetsujiro Kondo, Tokyo (JP); Kazutaka Uchida, Tokyo (JP); Yoshinori Watanabe, Kanagawa (JP); Ryotaku Hayashi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/681,715

(22) PCT Filed: Oct. 27, 2008
(86) PCT No.: PCT/JP08/69475

§ 371 Date: Apr. 5, 2010

(30) Foreign Application Priority Data
Nov. 2, 2007 (JP) 2007-286450

(51) Int. Cl. H04N 5/91

(52) U.S. Cl. 386/80; 386/E05.003

(57) ABSTRACT

The amount of information provided to the user is adjusted adaptively by means of a simple technique.

To this end, the present invention includes a character information extracting section 61 that extracts an image including character information from a picture whose playback speed is set to a predetermined speed, and outputs the extracted image to a first display section 2R of a plurality of display sections, a playback speed converting section 50 that converts the playback speed of an input picture on the basis of a given variable, and outputs the converted playback speed to the character information extracting section 61 and a display section 2L other than the first display section, and a playback speed determining section 40 that determines the playback speed of the picture on the basis of a change in position of a gaze detected by a gaze detecting section 3 detecting the position of the gaze of a user, and outputs a variable according to the determined playback speed to the playback speed converting section 50.

### TECHNICAL FIELD

The present invention relates to an information presentation apparatus and an information presentation method which are suitable for, for example, presenting information by using a plurality of display devices.

### BACKGROUND ART

In the related art, when attempting to efficiently acquire information from a picture or the like that is being played back on a display device or the like, playback in fast motion or the like is performed. This is because by playing back in fast motion, it is possible to increase the amount of information that can be acquired in unit time. However, when viewing a picture played back in fast motion, users (viewers) often miss necessary information.

If information is missed, an operation of rewinding the playback position may be simply performed. However, there is a problem in that a rewind operation needs to be performed every time missing occurs, which is troublesome. In addition, such an operation can lower the efficiency of information acquisition all the more.

For this reason, it is also common to adjust the playback speed automatically in accordance with features of a picture, such as lowering the playback speed in scenes with lots of motion or raising the playback speed in scenes with few motion in a picture to be played back.

For example, Japanese Unexamined Patent Application Publication No. 10-243351 describes about detecting visual features in a picture including sound, and playing back the picture while automatically adjusting the playback speed in accordance with the features.

Incidentally, there is a problem in that the technique described in Patent Document 1 cannot meet user's needs such as wanting to perform playback while raising the picture playback speed even in scenes with lots of motion. That is, the scene in which a user wants to lower or raise the picture playback speed differs depending on the condition in which each individual user is put, and the ability and preference of the user, and thus there is a problem in that adjustments based on features in a picture alone do not make it possible to provide information in a manner that meets user's diverse needs.

Furthermore, to optimize the amount of provision of information in accordance with the condition, ability, and preference of a user, first, it is necessary to measure the condition and ability of the user. However, measurement of such data requires use of a large-scale device such as an electro-encephalograph, an electrocardiogram, or NIRS (Near-Infrared Spectroscopy). That is, since the cost mounts up, it is often difficult to realize an information presentation system.

Another conceivable technique for acquiring internal conditions such as the user's condition, ability, and preference without using such a device is to make the user report these pieces of information by himself/herself. However, making the user perform a complicated operation such as a key input increases the load imposed on the user, and it is expected that this will hinder efficient acquisition of information by the user all the more.

The present invention has been made in view of the above points, and its object is to adjust the amount of information provided to a user adaptively by means of a simple technique.

### DISCLOSURE OF INVENTION

The present invention includes a character information extracting section that extracts an image including character information from a picture whose playback speed is set to a predetermined speed, and outputs the extracted image to a first display section of a plurality of display sections, a playback speed converting section that converts a playback speed of an input picture on the basis of a given variable, and outputs the converted playback speed to the character information extracting section and a display section other than the first display section, and a playback speed determining section that determines the playback speed of the picture on the basis of a change in position of a gaze detected by a gaze detecting section detecting a position of a gaze of a user, and outputs a variable according to the determined playback speed to the playback speed converting section.

Character information as so referred to herein includes not only characters but also information such as figures.

In this way, in cases such as when the user has missed character information on the screen being viewed, as the user moves the gaze to another screen in an attempt to check the character information, that movement is detected, and the picture playback speed is adjusted.

According to the present invention, since the picture playback speed is changed in accordance with the motion of the gaze of the user, the amount of information provided to the user is adaptively adjusted.

### BRIEF DESCRIPTION OF DRAWINGS

FIG. 1 is an explanatory diagram showing an example of the configuration of a system according to an embodiment of the present invention.

FIG. 2 is a block diagram showing an example of the internal configuration of the system according to an embodiment of the present invention.

FIG. 3 is a flowchart showing an example of processing in a playback speed determining section according to an embodiment of the present invention.

FIG. 4 is an explanatory diagram showing an example of processing in a playback speed converting section according to an embodiment of the present invention, of which (a) shows input frames, and (b) shows output frames.

FIG. 5 is an explanatory diagram showing another example of processing in the playback speed converting section according to an embodiment of the present invention, of which (a) shows input frames, and (b) shows output frames.

FIG. 6 is a flowchart showing an example of processing in a case when frames with large amounts of information are left according to an embodiment of the present invention.

FIG. 7 is an explanatory diagram showing another example of processing in the playback speed converting section according to an embodiment of the present invention, of which (a) shows input frames, and (b) shows output frames.

FIG. 8 is a flowchart showing an example of processing in a telop extracting section according to an embodiment of the present invention.

FIG. 9 is a schematic diagram showing an example of operation when checking a telop according to an embodiment of the present invention.

FIG. 10 is a flowchart showing an example of processing in the telop extracting section according to another example of an embodiment of the present invention.

FIG. 11 is an explanatory diagram showing an example of display of a telop according to another example of an embodiment of the present invention.

FIG. 12 is an explanatory diagram showing an example of display of a telop by a telop list according to another example of an embodiment of the present invention.

### BEST MODES FOR CARRYING OUT THE INVENTION

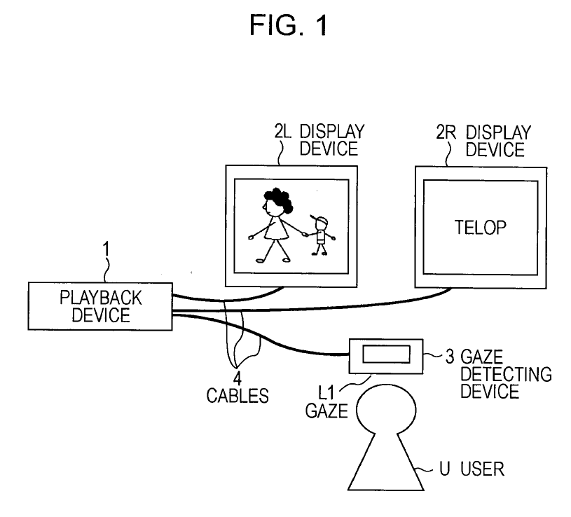

Hereinbelow, an example of an embodiment of the present invention will be described with reference to the attached drawings. An example of the configuration of a system according to this embodiment is shown in FIG. 1. The system shown in FIG. 1 includes a playback device 1 that plays back an image, a picture, or the like at a playback speed such as two-times speed, for example, display devices 2L and 2R that display a playback picture, and a gaze detecting device 3 that detects the position of a gaze L1 of a user U by the position of the eyes of the user U. The display devices 2L and 2R and the gaze detecting device 3 are connected to the playback device 1 by cables 4.

The display devices 2L and 2R are placed so as to be arranged in horizontal line so that at a position in the middle of both the screens of the display devices 2L and 2R, the user U can view a picture displayed on each of the screens. Then, information as to which of the screens of the display devices 2L and 2R the user U is viewing can be acquired by the gaze detecting device 3.

The gaze detecting device 3 detects the position of the gaze L1 of the user U, and sends out the detected result to the playback device 1 as gaze information. The gaze detecting device 3 is a device that detects the position of the gaze L1 of the user U, and is placed at a position allowing the gaze L1 of the user U to be readily detected, such as a position facing the user U, for example.

It should be noted that while this example uses a stationary type device as the gaze detecting device 3, gaze detection glasses of a type worn by the user U may be used. Alternatively, the position of the gaze L1 of the user U may be detected by a monitoring camera installed in a distant place. Alternatively, a rotating chair may be used as a chair on which the user U sits when viewing a picture, and a sensor capable of acquiring the angle of the seating surface may be embedded in the chair to detect the orientation of the body of the user U so that the detected orientation of the body is presumed to be the gaze direction.

Alternatively, gaze orientation information may be acquired by having the user U report the screen he/she is looking at, by using a remote control device or the like.

In FIG. 1, a picture read from an accumulating section 30 within the playback device 1 described later is displayed on the display device 2L placed on the left side as seen from the user U, and of the picture read from the accumulating section 30, an image in which a telop exists is extracted and displayed on the display device 2R placed on the right side as seen from the user U. A telop refers to characters, figures, or the like inserted in a picture displayed on a screen.

Under this configuration, if the user U has missed a telop displayed on the screen of the display device 2L which is being viewed, the user U moves the gaze to the display device 2R on which information of the telop is displayed. A situation in which the user U fails to read a telop completely is assumed to arise in cases such as when the picture playback speed is too fast in relation to the information acquisition ability of the user U, that is, when the amount of information provided to the user U is too large. Conversely, when the gaze L1 of the user U stays on the screen on the left side, it is assumed that the amount of information provided to the user U is either appropriate or small.

In this example, the picture playback speed is lowered when the gaze L1 of the user U has moved to the display device 2R side where only a telop is displayed, and the picture playback speed is raised when the gaze L1 stays on the display device 2L side where a picture is being displayed. Through such processing, the amount of information (character information) provided to the user U can be adjusted adaptively.

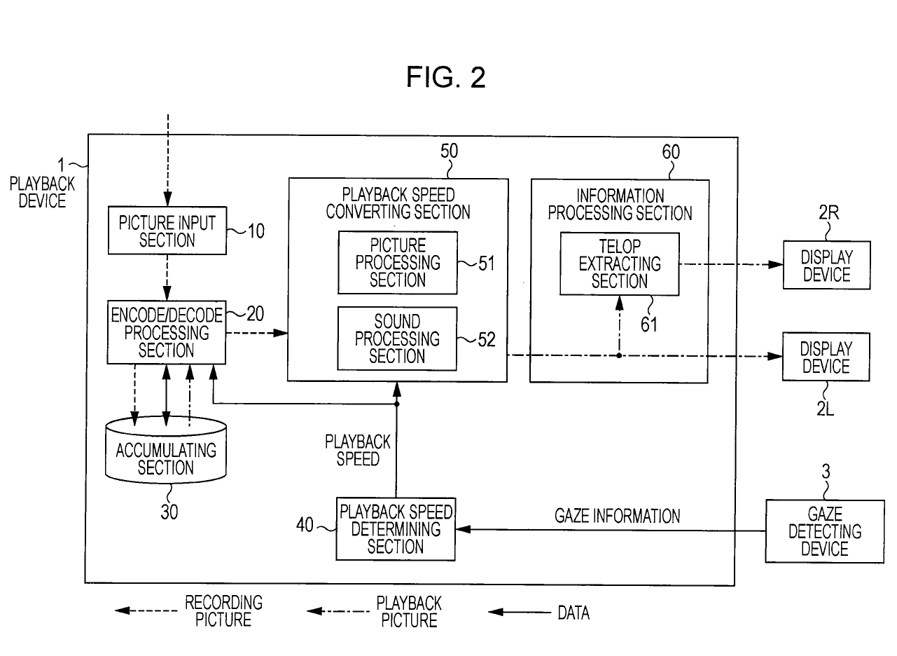

Next, an example of the internal configuration of the system will be described with reference to the block diagram shown in FIG. 2. The playback device 1 includes a picture input section 10, an encode/decode processing section 20, the accumulating section 30, a playback speed determining section 40, a playback speed converting section 50, an information processing section 60, and a telop extracting section 61 as a character information extracting section. In FIG. 2, a recording picture to be recorded onto the accumulating section 30 is indicated by broken lines, a playback picture to be played back on the display device 2L, 2R is indicated by alternate long and short dash lines, and data is indicated by solid lines.

The picture input section 10 captures a picture signal into the playback device 1 via an input terminal or the like, and performs a signal level conversion process. The encode/decode processing section 20 performs a process of encoding the picture signal inputted from the picture input section 10, and outputting the result as a recording picture to the accumulating section 30. Also, the encode/decode processing section 20 performs a process of reading and decoding compressed picture data accumulated in the accumulating section 30, and outputting the result to the playback speed converting section 50. As for the rate of encoding, the same rate as the frame rate of a picture inputted from the picture input section 10 is used, and decoding is performed on the basis of a playback speed Vk (unit: multiple times speed) transmitted from the playback speed determining section 40. Then, in the playback speed converting section 50, a process of converting a playback speed V at current time (at that point in time) to the playback speed Vk outputted from the playback speed determining section 40 is performed. The accumulating section 30 is configured by, for example, an HDD (Hard Disc Drive), and accumulates pictures encoded in the encode/decode processing section 20.

The playback speed determining section 40 has a variable Pinc for accelerating the current playback speed V, and a variable Pdec for slowing down the current playback speed V, and determines which of the variable Pinc and the variable Pdec is to be used, in accordance with the content of gaze information transmitted from the gaze detecting device 3. The value of Pinc may be any value that is larger than 1, and the value of Pdec may be any value that is larger than 0 but smaller than 1. In this example, a numerical value such as, for example, 1.2 is used as the variable Pinc and, for example, 0.8 is used as the variable Pdec. The playback speed determining section 40 multiplies the current playback speed V by one of the variables to calculate the playback speed Vk. Then, the calculated playback speed Vk is outputted to the playback speed converting section 50. Details about processing in the playback speed determining section 40 will be described later.

The playback speed converting section 50 includes a picture processing section 51 and a sound processing section 52. The picture processing section 51 performs a process of converting the playback speed so that the playback speed V of a picture outputted from the encode/decode processing section 20 becomes the playback speed Vk inputted from the playback speed determining section 40. Then, the picture whose playback speed has been converted is supplied to the information processing section 60. The sound processing section 52 performs a process of converting the playback speed without changing the pitch, by means of a technique such as removing silent portions or portions of continuous sound features in a sound signal. An example of specific processing for converting sound playback speed is described in Japanese Unexamined Patent Application Publication No. 2000-99097. Details about processing in the playback speed converting section 50 (picture processing section 51) will be described later.

The information processing section 60 includes the telop extracting section 61 that extracts a telop included in a picture. The information processing section 60 branches a picture and sound inputted from the playback speed converting section 50 in two ways, outputs one branched half directly to the display device 2L, and outputs the other branched half to the telop extracting section 61. The telop extracting section 61 is connected to the display device 2R, and a picture including a telop extracted by the telop extracting section 61 is outputted to the display device 2R. Details about processing in the telop extracting section 61 will be described later.

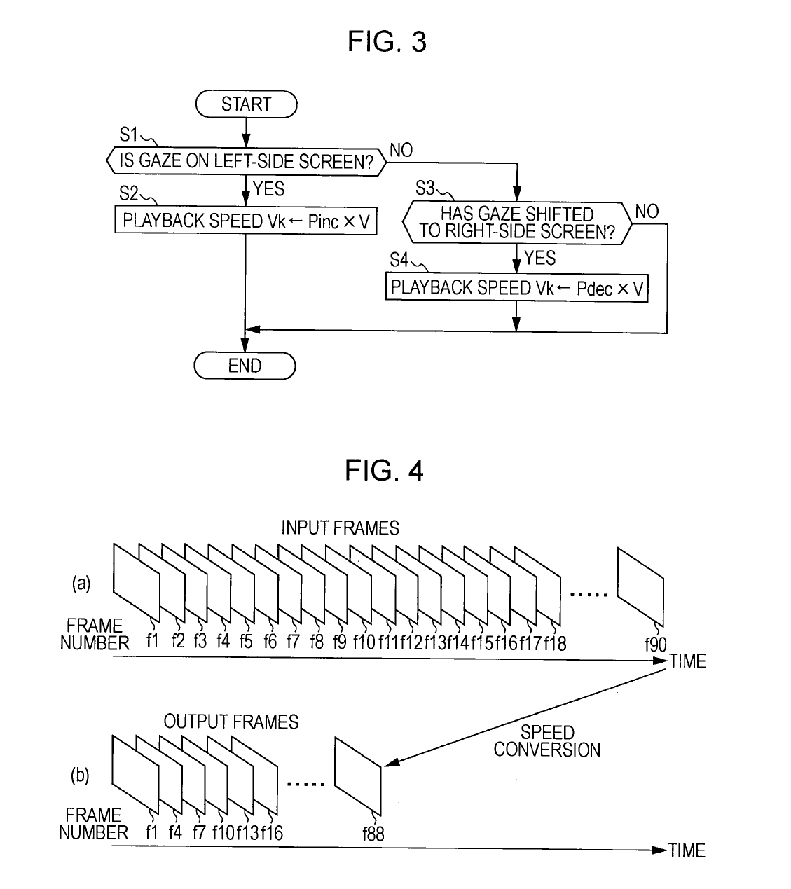

Next, referring to the flowchart in FIG. 3, a description will be given of processing in the playback speed determining section 40. The processing in the playback speed determining section 40 is performed every time gaze information is inputted from the gaze detecting device 3, and the cycle of gaze information output in the gaze detecting device 3 can be set by the user U to an arbitrary cycle such as an interval of one second, for example. In FIG. 3, on the basis of gaze information transmitted from the gaze detecting device 3, the playback speed determining section 40 judges whether or not the gaze L1 of the user U is on the screen of the display device 2L placed on the left side (step S1). If it is judged that the gaze L1 of the user U is on the screen of the display device 2L, the playback speed V at that point in time is multiplied by the variable Pinc to calculate the playback speed Vk (step S2). If Pinc is, for example, 1.2, and the playback speed V is 1-time speed, the playback speed Vk is 1.2×1=1.2-times speed. That is, if the gaze L1 of the user U is staying on the display device 2L, it is judged that there is still some room for the ability of the user U to acquire information, and a process of accelerating the playback speed is performed. It should be noted that the case when the playback speed V is 1-time speed refers to the case when playback is being performed while keeping the frame rate of pictures recorded in the accumulating section 30.

If it is judged in step S1 that the gaze L1 of the user U is not on the screen of the display device 2L placed on the left side, the processing proceeds to step S3, and it is judged whether or not the gaze L1 has moved to the screen of the display device 2R placed on the right side. Assuming that gaze information outputted from the gaze detecting device 3 is stored on an unillustrated memory or the like as history in advance, here, gaze information outputted from the gaze detecting device 3 and history information about gaze information are compared with each other to judge whether or not the position of the gaze L1 of the user U1 has changed in comparison to the previous gaze position. If the gaze L1 at previous time was also on the screen on the right side, “No” is selected, and the processing ends.

If the previous position of the gaze L1 was on the display device 2L, and the position of the gaze L1 at current time is on the display device 2R, this means that the gaze L1 has moved to the screen on the right side, so “Yes” is selected in step S3. Then, in the next step S4, a process of calculating the playback speed Vk is performed by multiplying the playback speed V at that point in time by the variable Pdec. If Pdec is 0.8, and the playback speed V at that point in time is 1-time speed, the playback speed Vk is 0.8(Pdec)×1(V)=0.8-time speed. The fact that the gaze L1 of the user U has moved to the right side can be judged as indicating that the user U has missed a telop. That is, since the condition of the user U is such that there is not much room for acquisition of information, a process of reducing the amount of information provided to the user U is performed by slowing down the playback speed V.

Next, referring to FIG. 4, an example of processing in the playback speed converting section 50 will be described. FIG. 4(a) shows a state in which frames inputted to the playback speed converting section 50 are sequentially arranged in time series from the left, and FIG. 4(b) shows a state in which individual frames outputted from the playback speed converting section 50 are likewise sequentially arranged in time series from the left. In FIG. 4, the respective frames are assigned frame numbers f1 to fn (n is a natural number).

The number of frames inputted to the playback speed converting section 50 is obtained as playback speed Vk×block size B. The block size B is calculated by multiplying the interval T of time at which the routine of the playback speed converting section 50 is carried out, by the frame rate fr of pictures accumulated in the accumulating section 30. For example, if the interval T of time at which the routine of the playback speed converting section 50 is carried out is one second, and the frame rate fr of pictures accumulated in the accumulating section 30 is 30 fps, the block size B is 1(T)×30(B)=30 (frames). Then, if the playback speed Vk is 3, the number of frames inputted to the playback speed converting section 50 is 30×3=90 (frames).

The number of frames inputted to the playback speed converting section 50 is, in other words, the number of frames extracted by the encode/decode processing section 20 from the accumulating section 30. The encode/decode processing section 20 calculates the number of frames to be extracted from the accumulating section 30, on the basis of the playback speed Vk inputted from the playback speed determining section 40, the frame rate fr of pictures recorded in the accumulating section 30, and the interval T of time at which the routine of the playback speed converting section 50 is carried out. Then, a number of frames equal to the calculated number of frames are extracted and outputted to the playback speed converting section 50.

FIG. 4(a) shows an example in which a picture of 90 frames is inputted to the playback speed converting section 50. The playback speed converting section 50 performs conversion of playback speed by thinning out frames at a fixed sampling interval so that the acquired frames fall with the block size B. For example, if the block size B is 30, a process of thinning out the acquired 90 frames in 3-frame units to 30 frames is performed. FIG. 4(b) shows the frames thinned out to 30 frames, illustrating that the thinned-out 30 frames are made up of frame numbers f1, f4, f7, f10 . . . f88 of the frames inputted from the encode/decode processing section 20. In the example shown in FIG. 4, the playback speed is increased by three times by performing such processing. Since this technique can be realized without using a complicated configuration, the scale of hardware can be kept small by using this technique.

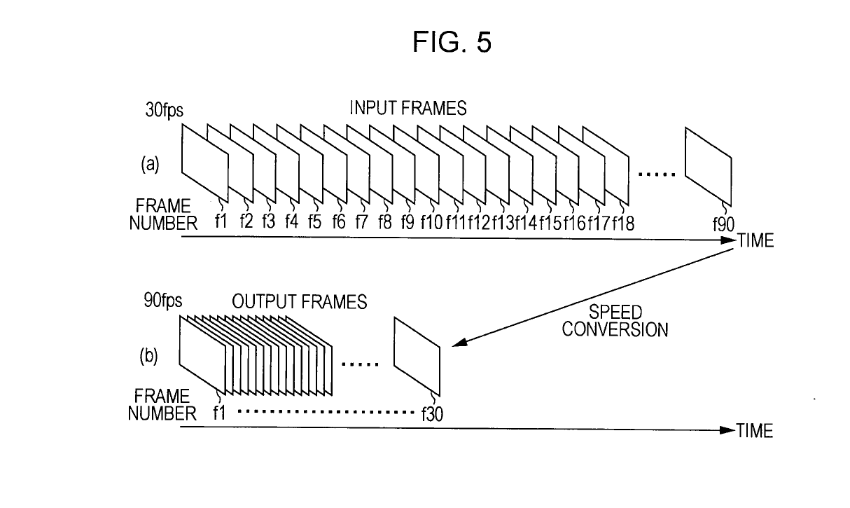

It should be noted that while the example shown in FIG. 4 is directed to the case in which conversion of playback speed is performed by thinning out frames inputted from the encode/decode processing section 20 at a fixed sampling interval, the playback speed may be converted by converting the frame rate itself. For example, by converting the frame rate of 90 frames shown in FIG. 5(a) from 30 fps to 90 fps, 90 frames' worth of picture may be outputted at a frame rate of 90 fps as shown in FIG. 5(b). Since all the inputted frames are outputted by this processing, flicker in the output picture is reduced, thereby making it possible to obtain a high-quality picture.

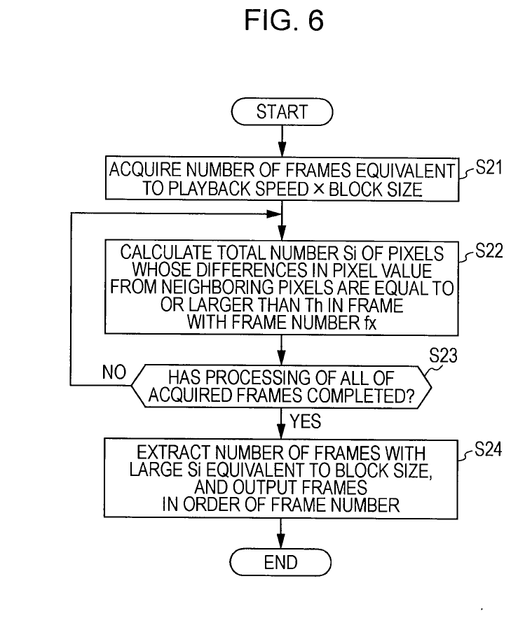

Alternatively, speed conversion may be performed by extracting only frames with large amounts of information as frames for playback, from among the frames inputted from the encode/decode processing section 20. An example of processing in this case is shown in the flowchart in FIG. 6. The processing shown in FIG. 6 is performed at an interval of one second (that is, T=1). First, by the encode/decode processing section 20, a number of frames equivalent to playback speed Vk×block size B are acquired from the accumulating section 30 (step S21). Next, after calculating the difference in pixel value between each target pixel and its neighboring pixels in a frame with a frame number fx (x represents a predetermined number between 1 to n), the total number Si of pixels whose differences in pixel value from neighboring pixels are equal to or larger than a threshold Th is calculated (step S22). That is, the total number Si of pixels mentioned above is calculated for all of frames inputted from the encode/decode processing section 20.

In step S21, for example, if the playback speed Vk is 1.5, and the block size is 30, 1.5×40=45 frames are acquired. Thus, frame numbers to be processed in step S22 are f1 to f45. As the threshold Th to be used in step S22, for example, a numerical value such as 50 is set.

The process in step S22 is performed with respect to all of the frames acquired in step S21. In step S23, it is judged whether or not processing of all the frames has been completed. If it is judged that processing has been completed in all of the frames, next, a process is performed which extracts a number of frames equivalent to the block size which have large total numbers Si of pixels whose differences in pixel value from neighboring pixels are equal to or larger than the threshold Th, and outputs the frames in order of frame number (step S24).

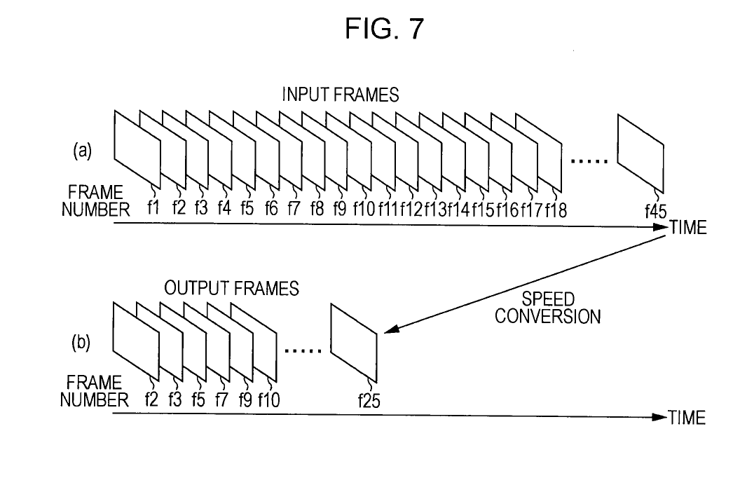

FIG. 7 shows an example in the case when such processing is performed. FIG. 7(a) shows a state in which 45 frames inputted to the playback speed converting section 50 are arranged from left in order of lowest frame number. FIG. 7(b) shows a state in which from among these 45 frames, a number of frames equivalent to the block size, that is, 30 frames with large Si, which represents the total number of pixels whose differences in pixel value from neighboring pixels are equal to or larger than the threshold Th, are extracted, and arranged in order of frame number. FIG. 7(b) shows that the 30 frames outputted from the playback speed converting section 50 are made up of frame numbers f2, f3, f5, f7, f9, f10 . . . f25.

That is, according to the method shown in FIG. 6 and FIG. 7, the playback speed can be accelerated (by 1.5 times in the example of FIG. 6 and FIG. 7) by extracting only frames with large amounts of information. Also, according to such processing, among input frames, frames that have a high possibility of including a large amount of character information such as a telop can be left, thus eliminating a situation in which information necessary for the user is deleted by the speed conversion process. This makes it possible for the user U to acquire information efficiently.

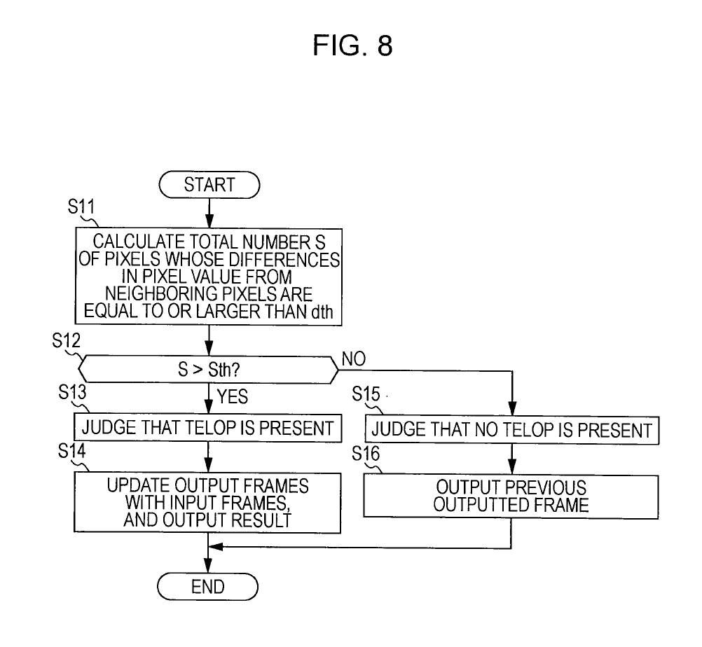

Next, referring to FIG. 8, an example of processing in the telop extracting section 61 will be described. It is assumed that the processing in the telop extracting section 61 is performed every time each frame constituting a picture is inputted to the telop extracting section 61. In FIG. 8, the telop extracting section 61 first calculates the difference in pixel value between each target pixel and its neighboring pixels in an inputted frame, and then calculates the total number S of pixels whose differences in pixel value from neighboring pixels are equal to or larger than a threshold dth (step S11). If pixel values are expressed in 8 bits (256 gray scales), for example, a value such as 100 is set as the threshold dth.

In the next step S12, it is judged whether or not the total number S of pixels calculated in step S11 is larger than a threshold Sth. As the threshold Sth, a value that is about 10% of the total number of pixels constituting one frame is set. If the size of a frame is, for example, 720 pixels×480 pixels, Sth=720×480×10%=34560 (pixels). It should be noted that the value of the threshold dh or threshold Sth can be set to an arbitrary value.

If it is judged that the total number S of pixels calculated in step S11 is larger than the threshold Sth, it is judged that the inputted frame includes a telop (step S13), and the frame to be outputted to the display device 2R is written over by the inputted new frame and outputted (step S14).

The telop extracting section 61 is configured to accumulate frames in an unillustrated memory or the like in advance, and continue to output the accumulated frames until a telop is detected in an inputted frame. Then, in step S14, if it is judged that an inputted frame includes a telop, each accumulated frame is written over by the inputted frame, so the frame that has been written over (i.e., input frame) is outputted to the display device 2R. In this way, an old telop remains displayed on the display device 2R until the next new telop is detected.

If it is judged in step S12 that the total number S of pixels is equal to or smaller than the threshold Sth, it is judged that no telop is included in the inputted frame (step S15), and the previous outputted frame, that is, an accumulated frame is outputted as it is (step S16). By performing such processing, on the display device 2R connected to the telop extracting section 61, of inputted pictures, only a picture including a telop is displayed. On the other hand, on the display device 2L, a picture outputted from the playback speed converting section 50 is displayed as it is without going through the telop extracting section 61.

It should be noted that in this example, in an inputted frame, the difference in pixel value between each target pixel and its neighboring pixels is calculated, and then the total number S of pixels whose differences in pixel value from neighboring pixels are equal to or larger than the threshold dth is calculated to thereby judge the presence/absence of a telop. However, this example is not limitative. For example, information indicating that, for example, the lower ⅕ region of the display screen is a region for displaying a telop may be described in metadata attached to content such as a picture, and the telop extracting section 61 (or the picture processing section 51) may analyze this information to judge the presence/absence of a telop. In such a case, even when information such as characters or figures is not present in the above-mentioned region in a picture, a telop can be judged to be present, and a picture including a telop can be displayed on the display device 2R. Also, if the presence/absence of a telop can be judged on a per content scene basis or the like by analyzing metadata, there is no need to judge the presence/absence of a telop on a per frame basis. Further, by extracting a picture signal corresponding to the lower ⅕ region of the display screen from an inputted picture signal and outputting the picture signal to the display device 2R, only a telop can be easily displayed on the screen of the display device 2R.

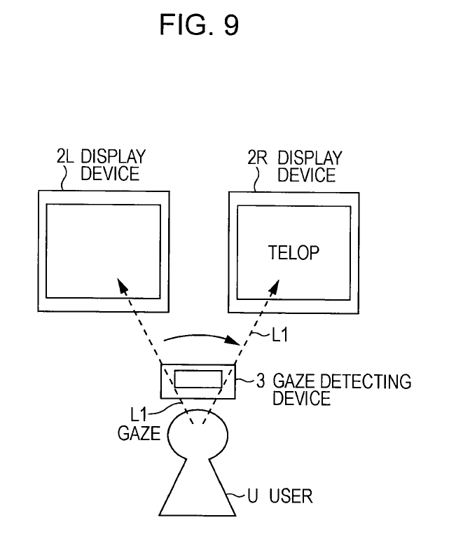

According to the configuration and processing in this embodiment described above, a picture read from the accumulating section 30 (see FIG. 2) is displayed on the display device 2L placed on the left side with respect to the user U, and of the picture read from the accumulating section 30, a picture including a telop is displayed on the display device 2R placed on the right side with respect to the user U. Thus, if the user has missed a telop on the screen of the display device 2L, the telop can be checked again by shifting the gaze L1 to the screen of the adjacent display device 2R as shown in FIG. 9.

Also, if the gaze L1 of the user U has moved onto the display device 2R on the right side, it is presumed that the user U has missed information, and the playback speed V of a picture displayed on each of the screens of the display devices 2L and 2R is reduced, so the amount of information presented to the user U in unit time decreases. That is, the amount of information provided to the user U approaches one that is appropriate for the information acquisition ability of the user U.

Also, if the gaze L1 of the user U is staying on the screen of the display device 2L, the playback speed V of a picture displayed on each of the screens of the display devices 2L and 2R is raised. Thus, in states in which there is still some room for acquisition of information by the user U, such as when missing of information by the user U has not occurred, the amount of information presented to the user U in unit time increases. Thus, the amount of information provided to the user U approaches one that is appropriate for the information acquisition ability of the user U.

In addition, since the configuration is such that the amount of picture presented is adjusted on the basis of the motion of the gaze L1 of the user U, there is no need for the user U to perform a special operation for notifying his/her own internal conditions. Thus, the user U can concentrate on the acquisition of information provided from the display section 2L or 2R.

It should be noted that the above-mentioned embodiment is configured such that if the gaze L1 of the user U has stayed for a fixed time on the screen on the side where a picture is displayed, it is regarded that there is still some room for acquisition of information by the user U, and the picture playback speed is raised. However, a configuration is also possible in which the playback speed is not changed if the gaze L1 of the user U has stayed on a specific screen for a fixed time.

Also, in the above-mentioned embodiment, a picture is displayed on the display device on the left side with respect to the user U, and only a picture including a telop is displayed on the display device on the right side. However, the left and right of the configuration may be reversed. That is, a normal picture may be displayed on the display device on the right side with respect to the user U, and only a picture including a telop may be displayed on the display device on the left side.

Also, in the above-mentioned embodiment, a picture included in a telop is displayed on the display device 2R. However, any information including a telop may suffice, be it a moving image or a still image. Alternatively, only a telop may be displayed as character information on the entire screen or a part of the screen.

Also, while the above-mentioned embodiment is directed to the example in which the presence/absence of a telop is judged on a per frame basis, the embodiment may also be applied to a configuration in which a telop extending over a plurality of frames is regarded as a single meaningful chunk, and the chunk with the telop is rewound and displayed on the display device 2R. By such a configuration, even in cases such as when a telop is displayed one character by one character or for every given chunk in accordance with the picture (flow of time), or when a single long sentence moves from the left side to right side of the screen or the like as a telop, the user can check the content of a missed telop again by shifting the gaze L1 to the display device 2R.

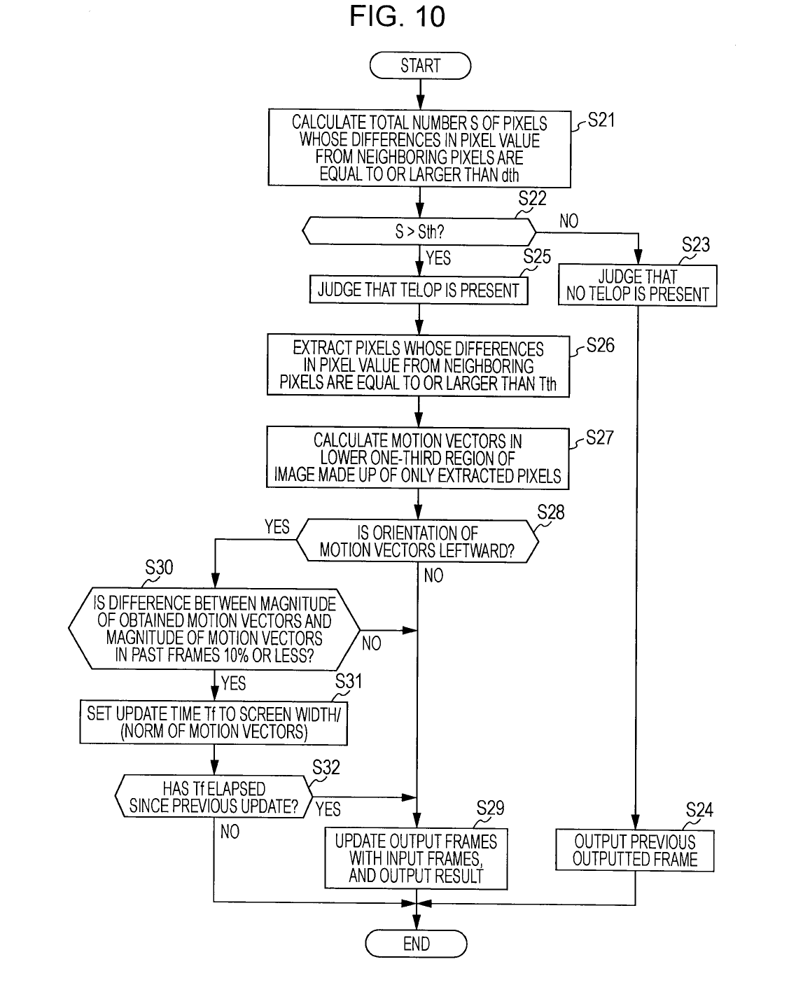

FIG. 10 shows an example of processing in the telop extracting section 61 in this case as a flowchart. In FIG. 10, the telop extracting section 61 first calculates the difference in pixel value between each target pixel and its neighboring pixels in an inputted frame, and then calculates the total number S of pixels whose differences in pixel value from neighboring pixels are equal to or larger than the threshold dth (step S21). The value of the threshold dth set here is the same value (100 or the like) as the threshold dth in FIG. 8. Next, it is judged whether or not the total number S of pixels calculated in step S11 is larger than the threshold Sth (step S22). The value of the threshold Sth is also set as the same value as the threshold Sth in FIG. 8. Thus, the threshold Sth is set to a value that is about 10% of the total number of pixels constituting a single frame. The processing performed up to this point is the same as that of steps S11 to 12 in FIG. 8. That is, the judgment as to whether or not a telop is included in an input frame is made irrespective of whether or not the telop is moving.

If it is judged that the total number S of pixels is equal to or smaller than the threshold Sth, it is judged that no telop is included in the inputted frame (step S23), and the previous outputted frame, that is, an accumulated frame is outputted as it is (step S24). If it is judged that the total number S of pixels is larger than the threshold Sth, it is judged that a telop is included in the inputted frame (step S25), and next, a process is performed which extracts pixels whose differences in pixel value from neighboring pixels are equal to or larger than a threshold Tth in the input frame (step S26). Here, a process of extracting only those portions which are considered to be edges from an image is performed. Thus, as the value of the threshold Tth, a value such as 80 is used.

Next, in an image made up of only the pixels extracted in step S26, motion detection based on block matching is performed with its lower one-third region as a target, thereby calculating motion vectors (step S27). Here, the target of block matching is limited to the lower one-third region of an image because this region is set as a region where a telop in a moving form is predicted to appear. Since a telop in a moving form is displayed at the lower end of the screen in many cases, in this example, the lower one-third region of an image is set as the predicted region of appearance of a telop. It should be noted that a region other than the lower one-third of an image may be set as the predicted region of appearance of a moving type telop.

Then, it is judged whether or not the orientation of the calculated motion vectors is leftward (step S28). If the orientation of the motion vectors is rightward, a process of updating a frame to be outputted with an inputted frame is performed (step S29). Since a telop in a moving form normally moves in the direction from right to left of the screen, in the case of an image including such a telop, the orientation of detected motion vectors should also become leftward. The fact that the direction of motion vectors is rightward can be judged as meaning that no pixel constituting a moving type telop is included in an input frame. Accordingly, each inputted frame is sequentially outputted, without performing a process of extracting a single chunk of telop.

If the orientation of the motion vectors is leftward, next, it is judged whether or not the difference between the magnitude of the calculated motion vectors and the magnitude of the motion vectors in the past N frames is 10% or less (step S30). Here, whether or not the moving speed of the telop made up of the pixels extracted in step S26 is constant is judged on the basis of the degree of the difference in magnitude between both the motion vectors.

If the difference between the magnitude of the calculated motion vectors and the magnitude of the motion vectors in the past N frames is 10% or less, it is judged that the telop is moving at constant speed. Then, as an interval Tf at which an output frame is updated by an input frame, a value obtained by (screen's horizontal width/motion vectors' norm) is set (step S31). By obtaining the motion vectors in a predicted region of telop appearance, the amount of movement of a telop on a per frame basis can be found. That is, the value calculated by (screen's horizontal width/motion vectors' norm) represents the time in which the telop moves across the display screen from right to left. Thus, the image displayed on the screen of the display device 2R is updated at that time interval.

Next, it is judged whether or not the update interval Tf has elapsed since the previous update, that is, since the time at which an output frame is updated with an input frame and outputted (step S32). If Tf has elapsed, a process of updating an output frame with an input frame and outputting the result is performed at this point in time (step S29). If the update interval Tf has not elapsed, the processing ends here. Through this processing, the image (frame) displayed on the display screen 2R is updated every time the update interval Tf set in accordance with the moving speed of a telop elapses. That is, a single chunk of moving type telop is displayed on the screen of the display device 2R as a still image.

If it is judged in step S30 that the difference between the magnitude of the calculated motion vectors and the magnitude of the motion vectors in the past N frames is larger than 10%, the processing proceeds to step S29, and a process of updating a frame to be outputted with an inputted frame and outputting the result is performed. That is, since it is judged that the telop is not moving at constant speed in this case, each inputted frame is sequentially outputted, without performing a process of extracting a single chunk of telop.

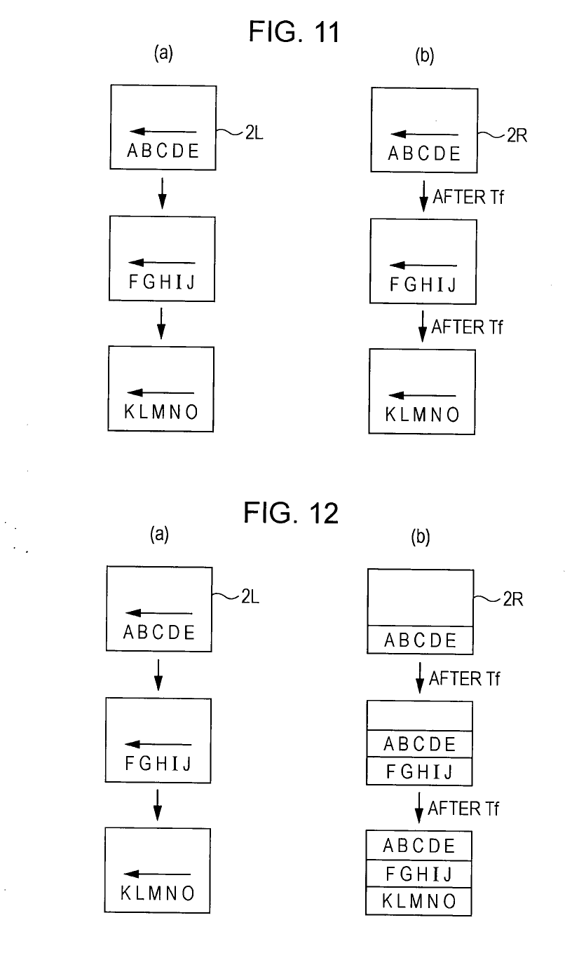

FIG. 11 shows an example of display in the case when the screen displayed on the display device 2R is updated at every update interval Tf. FIG. 11(a) shows an example of transition of screen display on the display device 2L, and FIG. 11(b) shows an example of transition of screen display on the display device 2R. FIG. 11(a) shows the movement of a telop in the direction from right to left on the display device 2L, illustrating the elapse of time in order from the screen shown at the top to the screen shown at the middle and then to the screen shown at the bottom. The “ABCDE” portion of a telop made up of a character string “ABCDEFGHIGKLMNO” is displayed on the screen in the top row of FIG. 11(a), the “FGHIG” portion is displayed on the screen in the middle row, and the “KLMNO” portion is displayed on the screen in the bottom row.

Supposing that the telop “ABCDEFGHIGKLMNO” is moving at constant speed, the processes in steps S31, S32, and S29 in FIG. 10 are performed. As these processes are performed, the image (telop) displayed on the display device 2R becomes as shown in FIG. 11(b).

In step S31 in FIG. 10, the time until the telop moves across the screen from right to left is set as the update interval Tf. Then, if it is judged in step S32 that the update interval Tf has elapsed since the previous update, an input frame for which “Yes” has been selected in the judgment in step S30 is outputted. Since the frame outputted here is a frame including the “ABCDE” portion of the telop, the display on the display device 2R becomes as shown in the top row of FIG. 11(b). That is, a frame (still image) including the telop “ABCDE” is displayed. Updating of display on the display device 2R is performed at every update interval Tf. Thus, for example, during the time from when a character “A” constituting the telop appears at the right end of the screen and then moves to the left end of the screen until “ABCDE” is displayed as shown in FIG. 11(a), the telop displayed on the screen of the display device 2R is not updated.

When the update interval Tf elapses from the time at which the screen shown in the top row of FIG. 11(b) is displayed, a still image including the telop “FGHIJ” is displayed on the screen of the display device 2R as shown in the middle row of FIG. 11(b). Then, when the update interval Tf further elapses from the time at which the screen shown in the middle row of FIG. 11(b) is displayed, a still image including the telop “KLMNO” is displayed on the screen of the display device 2R as shown in the bottom row of FIG. 11(b).

By performing such processing, even in the case of a telop in a form that moves on the screen, a single chunk of telop is displayed as a still image on the display device 2R installed on the right side of the user. Thus, even when the user has missed a telop on the screen of the display device 2L, the missed telop can be checked again by moving the gaze L1 to the display device 2R side.

It should be noted that in the case in which a moving type telop is displayed on the display device 2R again, it is assumed that the frequency with which content displayed on the screen of the display device 2R is updated becomes high. Accordingly, as shown in FIG. 12(b), a plurality of telop images may be combined so as to display telops in a list form in a single image. In this case, the telop extracting section 61 first performs a process of cutting out the region in the bottom row of the screen in which a telop is displayed. Then, every time the update interval Tf elapses, the cut out strip-shaped region is moved to the upper side in the screen, and a newly cut off strip-shaped region is displayed so as to be arranged in a region below the region that has been moved.

By performing such processing, after the elapse of the update interval Tf, the telop “ABCED” shown on the screen in the top row of FIG. 12(b) moves to the middle portion of the screen as shown in the middle row of FIG. 12(b), and the telop “FGHIJ” is newly displayed in the region below. When the update interval Tf further elapses from the state shown in FIG. 12(b), as shown in FIG. 12(c), “ABCDE” is displayed in the top row of the screen, “FGHIJ” is displayed in the middle row, and “KLMNO” is displayed in the bottom row.

By adopting such form of display, a telop is displayed on the screen of the display device 2R for a long period of time, making it easier for the user to check the telop again.

Also, while the above-mentioned embodiment is directed to the example in which the display devices 2 are arranged in horizontal line, the display devices 2 may be arrayed in another form, such as in vertical line or in oblique line.

Also, while the above-mentioned embodiment is directed to the example in which two display devices 2 are used, another number of display devices 2, such as three or four, may constitute an information presentation apparatus.

Also, while the above-mentioned embodiment is directed to the example in which a plurality of display devices 2 are used, the screen of a single display device 2 may be split into a plurality of display regions, and a picture may be outputted with respect to each of the split display regions.

### EXPLANATION OF REFERENCE NUMERALS

1 playback device, 2, 2L, 2R display device, 3 gaze detecting device, 4 cables, 10 picture input section, 20 encode/decode processing section, 30 accumulating section, 40 playback speed determining section, 50 playback speed converting section, 51 picture processing section, 52 sound processing section, 60 information processing section, 61 character information extracting section, 61 telop extracting section, B block size, L1 gaze, Pdec, Pinc variable, S, Si total number, Sth threshold, T, Tf update interval, Th, Tth threshold, U user, V, Vk playback speed, dh, dth threshold, f1, f2 frame number, fr frame rate, fx frame number

1. An information presentation apparatus comprising:
a character information extracting section that extracts a picture including character information from a picture whose playback speed is set to a predetermined speed, and outputs the extracted picture to a first display section of a plurality of display sections;
a playback speed converting section that converts a playback speed of an input picture on the basis of a given variable, and outputs the converted playback speed to the character information extracting section and a display section other than the first display section; and
a playback speed determining section that determines the playback speed of the picture on the basis of a change in position of a gaze detected by a gaze detecting section detecting a position of a gaze of a user, and outputs a variable according to the determined playback speed to the playback speed converting section.

2. The information presentation apparatus according to claim 1, wherein the playback speed converting section outputs a variable that slows down the playback speed of the picture, if the position of the gaze of the user has moved from the first display section to another display section.

3. The information presentation apparatus according to claim 2, wherein the playback speed determining section outputs a variable that accelerates the playback speed of the picture, if the position of the gaze detected by the gaze detecting section stays on a screen of the other display section.

4. The information presentation apparatus according to claim 2, wherein the playback speed determining section does not change the playback speed of the picture, if the position of the gaze detected by the gaze detecting section stays on a screen of the other display section.

5. The information presentation apparatus according to claim 2, wherein the character information extracting section calculates, in each frame of an inputted picture, a total number of pixels whose differences in pixel value from neighboring pixels are equal to or larger than a predetermined value, and judges that the inputted picture includes character information if the calculated total number is larger than a predetermined value.

6. The information presentation apparatus according to claim 5, wherein if character information is included in the inputted picture, the character information extracting section judges whether or not the character information is moving in a predetermined direction at a predetermined speed, and upon judging that the character information is moving in the predetermined direction at the predetermined speed, changes a time interval at which the picture including the character information is outputted to the display section, in accordance with a moving speed of the character information.

7. The information presentation apparatus according to claim 6, wherein the character information extracting section sets a cycle in which the picture including the character information is outputted to the display section, to a value obtained by dividing a width of a screen of the display section by the moving speed of the character information.

8. The information presentation apparatus according to claim 2, wherein the playback speed converting section converts the playback speed of the picture by thinning out frames constituting the input picture at a predetermined interval.

9. The information presentation apparatus according to claim 2, wherein the playback speed converting section converts the playback speed of the picture by changing a frame rate of the input picture.

10. The information presentation apparatus according to claim 2, wherein the playback speed converting section converts the playback speed of the picture by calculating a total number of pixels whose differences in pixel value from neighboring pixels are equal to or larger than a predetermined value, in each of frames of the input picture, and outputting a predetermined number of frames in order from a frame in which the calculated total number is large.

11. The information presentation apparatus according to claim 2, wherein the display section is each of split regions obtained when a single screen is split into a plurality of regions.

12. An information presentation method comprising:
a step of extracting a picture including character information from a picture whose playback speed is set to a predetermined speed, and outputting the extracted picture to a first display section of a plurality of display sections;
a step of converting a playback speed of an input picture on the basis of a given variable, and outputting the converted playback speed to a display section other than the first display section; and
a step of determining the playback speed of the picture on the basis of a change in position of a gaze detected by a gaze detecting section detecting a position of a gaze of a user, and outputting a variable according to the determined playback speed.
